(19) United States
(12) Patent Application Publication
(10) Pub. No.: US 2004/0204096 A1
(43) Pub. Date: Oct. 14, 2004

(54) RF and BB subsystems interface

(75) Inventors: Olaf J. Hirsch, Sunnyvale, CA (US); Guido Frederiks, Sunnyvale, CA (US); Steffen Hahn, Los Altos, CA (US); Emmanuel Riou, Santa Clara, CA (US)

Correspondence Address: Corporate Patent Counsel;, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/124,008

(22) Filed: Apr. 16, 2002

Related U.S. Application Data
(60) Provisional application No. 60/363,716, filed on Mar. 8, 2002.

(51) Int. Cl. H04M 1/00

(52) U.S. Cl. 455/561; 455/422.1

(57) ABSTRACT

A digital interface for a wireless communication system is provided with a reduced number of connectors. A first connector conveys a data signal between the radio frequency and the baseband circuitries. The data signal represents a digital baseband signal received or to be transmitted over the wireless network. The data signal is a multilevel data signal and conveys more than one bit of a sample of the digital baseband signal at a time. The radio frequency circuitry synchronizes the transfer of the data signal with a synchronizing clock provided by the baseband circuitry. The baseband circuitry controls the operational mode of the communication system via a control signal representative of command to the radio frequency circuitry. The control signal represents commands of various lengths thereby enabling fast transfer of critical commands.

### REFERENCE TO CROSS-RELATED APPLICATIONS

This application claims benefit of US provisional application serial No. 60/363,716, filed Mar. 8, 2002 (US docket US028018P) for the same inventors.

### FIELD OF THE INVENTION

The invention relates to a digital interface between a radio frequency subsystem and a baseband subsystem and in particular to a wireless communication system where the radio frequency circuitry and the baseband circuitry are built distant from each other.

### BACKGROUND ART

The wireless industry has made proposals for various interface designs, however these designs are often uniquely associated with a vendor and/or a platform. Problems thus arise when RF subsystems and BB subsystems of different manufacturers cannot communicate and operate together. Some players have tried to impose their own specification of a standardized wireless interface and so far none has received approval and full support of the wireless industry.

One proposed vendor and platform independent interface is disclosed in the PCT publication WO 00/42744, herein incorporated by reference. The described interface comprises a plurality of connectors for controlling the RF circuitry including providing control information for changing the mode of operation of the transceiver. The interface has pins assigned to a bus of control signals. A separate pin is assigned to a sleep control signal only and other pins are assigned to a bus of data signals.

### SUMMARY OF THE INVENTION

The interface disclosed in the document WO 00/42744 requires an extra pin solely for the sleep signal, which extra pin complicates the interface and increases its cost. Besides, the proposed interface does not seek to enhance the bandwidth efficiency and does not address issues related to latencies of control commands. All control commands are transmitted in the same manner whether they require low latency responses or whether their timing is not as critical. The inventors have realized that the performance of this interface and other existing interfaces could be ameliorated and that use of the data bandwidth could be enhanced.

An object of the invention is to provide a more efficient and simpler interface.

Another object of the invention is to provide a standardized interface between a RF subsystem and a BB subsystem to simplify the task of developers and vendors of wireless communication systems.

Another object of the invention is to provide a high data bandwidth digital interface for fast transfer of data and control information between RF and BB subsystems.

It is yet another object of the invention to provide RF and BB subsystems with a reduced number of pins.

To this end, a digital interface of the invention comprises a plurality of connectors. A first connector is used for conveying a synchronizing clock signal from the BB subsystem to the RF subsystem. The RF subsystem synchronizes the transfer to the BB subsystem of a multilevel data signal with this synchronizing clock. The multilevel data signal is conveyed on a second connector and the multilevel data signal is representative of a baseband communication signal associated with a radio frequency signal received by the RF subsystem over the wireless network. A third connector is used to convey from the BB subsystem to the RF subsystem a control signal representative of a command for controlling an operating mode of the RF subsystem. The interface also comprises a fourth connector conveying a reference clock signal to the BB subsystem and a fifth connector conveying a signal strength indicator signal to the BB subsystem, the signal strength indicator signal indicating a strength of the radio frequency signal received by the RF subsystem.

An interface of the invention allows minimizing a number of connectors between the two subsystems. A connector is either a single signal line or a multiple lines bus. The five connectors may be physically independent from each other. In an example embodiment, the interface may be designed with 5 pins only: a pin for the data bus, a pin for the control bus and a pin for each of the third, fourth and fifth connectors. An advantage of the invention is therefore to provide a communication interface with a low pin count.

The second connector enables transfer of multilevel data signal. The conveyed data signal represents samples of a digital baseband signal received over the wireless network. In an embodiment, the data signal may also be representative of a digital baseband signal to be transmitted by the RF subsystem over the wireless network. The sample bits are translated into voltage levels of the data signal and more than one bit may be represented by one voltage level conveyed on a single line. Thus, several bits may be transmitted at a time on a given line. The data throughput of the interface is thereby enhanced and the pin count is reduced. The bandwidth efficiency of the interface may be further enhanced by augmenting the number of voltage levels used in the representation of the digital data. Indeed four voltage levels may be used to convey the four 2-bits values and eight voltage levels may be used to convey the eight 3-bits values. If four voltages are used to convey the four 2-bits values, then two bits are transmitted at a time.

Another advantage of an interface of the invention with respect to an analog interface is that the invention enables to place the RF and BB subsystem far from each other without impacting the overall performance of the communication system. For example, the RF and BB subsystems of a wireless communication system designed for a laptop may be integrated in different places: the RF subsystem may be integrated or attached to the top of the laptop display and the BB MAC subsystem may be fully integrated in the processing hardware of the laptop.

In an embodiment, the second connector is bidirectional and the data signal is conveyed in one direction or another depending on the operating mode of the RF subsystem. As mentioned above, the conveyed data signal may be representative of a baseband signal received or to be transmitted over the wireless network. In the transmitting mode, the data signal conveyed to the RF subsystem represents the baseband signal for transmission over the wireless network. In the receiving mode, a RF signal received at the RF subsystem over the wireless network is converted to a digital baseband signal. The digital baseband signal is then sampled before conveyance to the BB subsystem. The baseband signal may comprise in-phase and quadrature components conveyed together or separately to the BB subsystem. Transmission of the data signal from the RF subsystem to the BB subsystem is synchronized based on the synchronizing clock signal transmitted over the first connector.

In an embodiment of the invention, the data signal is transmitted using time division multiplexing and a sample of the BB signal is transmitted in more than one clock cycle. Such an embodiment permits to further reduce the number of communication lines, and as a result the number of pins of the interface. For example, the quadrature and in-phase components of the samples of the baseband data signal are conveyed at a rate being twice the sampling rate of generating them. Thus, it takes two clock cycles to transmit each component of each sample of the baseband signal. In an embodiment, the in-phase and quadrature components of each sample of the baseband signal are transmitted in parallel and in this case, it takes two clock cycles to transmit each sample of the baseband signal from the RF subsystem to the BB subsystem.

In another embodiment of the invention, the control signal represents control commands of variable lengths. The length of the command is determined based on a timing criticality of the command. Thus, a critical command, which ought to be quickly transmitted to the RF subsystem, is transmitted as a short control word. A command, for which timing and delays are not critical, such as for general commands, is transmitted as a long control word.

In yet another embodiment of the invention, the control signal may be a multilevel signal to further improve the bandwidth efficiency of the interface.

### BRIEF DESCRIPTION OF THE DRAWINGS

The invention is explained in further details, by way of examples, and with reference to the accompanying drawing wherein:

FIG. 1 is a wireless communication system of with an interface of the invention;

FIG. 2 is a timing diagram illustrating the transmission of a control signal RFCTRL;

FIG. 3 shows the structure of a control command represented by the control signal RFCTRL;

FIG. 4 shows the four voltage values of a multilevel data signal transmitted over the data connector;

FIG. 5 is a timing diagram illustrating the synchronization of the transfer of the data signal BBDATA on the falling edge of the clock synchronizing BBCLK; and

FIG. 6 is another timing diagram illustrating the synchronization of the transfer of the data signal BBDATA on the rising edge of the synchronizing clock BBCLK.

Elements within the drawing having similar or corresponding features are identified by like reference numerals.

### DETAILED DESCRIPTION

The invention pertains to a digital interface for the communication of informative and control signals between a baseband subsystem and a radio frequency subsystem in a wireless communication system. The wireless system is possibly built based on one of the various wireless LAN communication standards, e.g. HiperLAN2, IEEE 802.11 a/b/e/g or Bluetooth. It is to be noted that the invention encompasses any interface, which has the characteristics of the invention and which additionally implements requirements of an existing or future wireless standard.

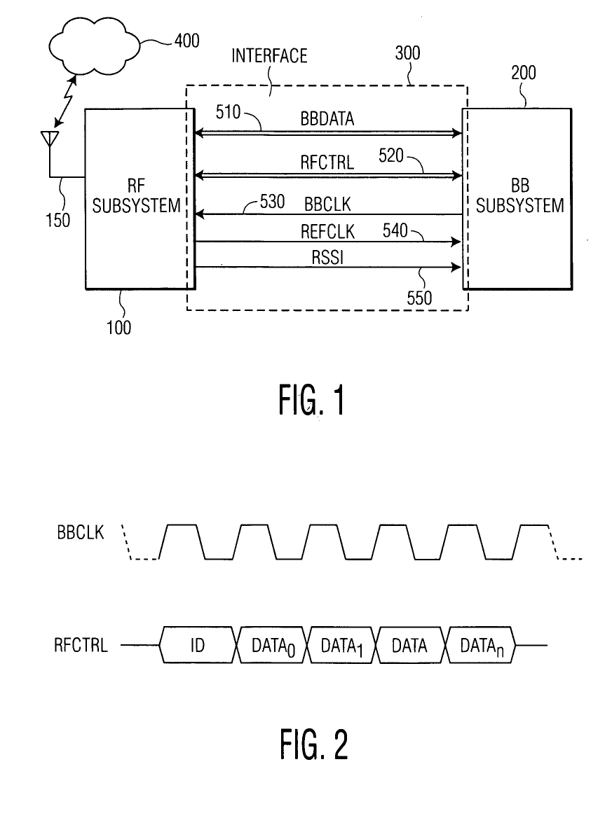

FIG. 1 shows a wireless communication system 300 comprising a radio frequency subsystem 100 and a baseband subsystem 200 communicating with each other via a digital interface 500 of the invention. The RF subsystem 100 receives and transmits RF signals over a wireless network 400 via an antenna 150. The interface 500 comprises a plurality of connectors 510-550. A first connector 510 conveys a data signal BBDATA representing a digital baseband signal received or to be transmitted by the RF subsystem 100 over the wireless network 400. A second connector 520 conveys a control signal RFCTRL between the BB subsystem 200 and the RF subsystem 100. The control signal RFCTRL is used by the BB subsystem 200 to control the operating mode of the RF subsystem 100, and to read and/or write registers of the RF subsystem 100, as will be explained hereinafter. A third connector 530 conveys a clock signal BBCLK used as a reference clock for synchronizing the transfer of the data signal BBDATA and RFCTRL via the connector 510 from the RF subsystem 100 to the BB subsystem 200. A fourth connector 540 conveys a reference clock signal REFCLK from the RF subsystem 100 to the BB subsystem 200 thereby providing a common reference clock to the wireless system 300. A fifth connector 550 conveys a received signal strength indicator signal RSSI indicating to the BB subsystem 200 a strength of a RF signal received at the RF subsystem 100 over the wireless network 400.

The control signal RFCTRL conveyed on the connector 520 is representative of a control command transmitted from the BB subsystem 200 to the RF subsystem 100 and/or a response from the RF subsystem 100 to the BB subsystem 200. Each control command comprises an initial 3-bits ID word indicative of an operating mode of the interface 500 and comprises data words DATA0, . . . , DATAn following the ID word (when applicable), as shown in FIG. 2. The ID word defines the structure of data following the ID word. An ID word 111 indicates a synchronization of the time division multiplex transfer of the BBDATA signal with the clock BBCLK. No additional data follows the ID word 111. An ID word 000 indicates no activity of the wireless system 300. An ID word 001 indicates a short control word and one data word DATA1 is sent following the ID word.

FIG. 3 depicts the structure of a control command with an ID word 010. The ID word 010 indicates a long control word and is followed by several other data words. In this embodiment the first two words after the ID word 010, bits A0 to A5, contain the address information of a register of the RF subsystem 100. Then a third word contains the address bit A6 and a R/W bit indicative of whether the addressed register is read or written. A fourth word may be set to zero and this empty word is used to give the RF subsystem 100 time to switch from reading data on the interface 500 to writing data to the interface 500. A fifth word and other subsequent words, bits D0-D23, contain the register value and these words are either written by the BB subsystem 200 or the RF subsystem 100 depending whether the R/W bit indicates a writing or a reading operational mode. The control command depicted in FIG. 3 comprises a total of 13 words: the ID word and 12 data words. When reading data from one or more registers of the RF subsystem, the ID word and the first 4 data words represent the reading control command and these 5 words are conveyed in the direction from the BB subsystem 200 to the RF subsystem 100 whereas the last 8 data words are conveyed in the other direction, from the RF subsystem 100 to the BB subsystem and contain the values read from the one or more registers of the RF subsystem 100.

Another ID word 100 is used to set the automatic gain control (AGC) loop value and enables to set the RF subsystem 100 in the receiving operating mode. The ID word 100 is followed by preset AGC values. In this embodiment, the ID word 100 is followed by 8 ACG preset values. An ID word 011 defines the start of a cycle of the AGC loop in the RF subsystem 100. An ID word 101 may be unused and reserved for future use.

In this embodiment, the control signal RFCTRL represents commands of variable length, e.g. a control command with the ID word 111 comprises one word only whereas the control signal RFCTRL with ID word 010 comprises 13 different words in the example shown in FIG. 3. The use of variable length control commands permits to more quickly convey control commands for which timing is critical. Such implementation permits to increase the data throughput of the interface 500. Indeed, control commands with only the ID word and no data word are used for fast control of the RF subsystem 100. Control commands with the ID word and one data word are used for fast control of the RF subsystem with a limited set of parameters whereas the long control commands are used for general control of the RF subsystem 100. In this embodiment, the BB subsystem 200 acts as the master in a master-slave configuration and the RF subsystem 100 as the slave.

As mentioned above transmission of the data signal BBDATA from the RF subsystem 100 to the BB subsystem 200 is synchronized based on the synchronizing clock signal BBCLK, and, in the same manner, the transfer of the control signal RFCTRL is synchronized using the synchronizing clock signal BBCLK. The control signal RFCTRL and the data signal BBDATA may be synchronized on the rising or falling edge of the clock signal BBCLK with a preset delay as will be explained hereinafter.

In an embodiment, the signals BBCTRL and BBDATA may be conveyed over the same connector and the second connector 520 and the third connector 530 are thus physically implemented as a one connector.

In the embodiment depicted in FIG. 1, the first connector 510 is bi-directional and the direction of conveyance of the signal BBDATA depends on the operating mode of the RF subsystem 100: reception of RF signal or transmission over the wireless network 400 of a BB signal received from the BB subsystem 200. In the receiving mode, a RF signal received by the antenna 150 is converted to a BB signal and sampled by the RF subsystem 100 before conveyance to the BB subsystem 200. In the transmission mode, a BB signal is conveyed by the BB subsystem 200 to the RF subsystem 100 via the connector 510, further converted to a RF signal and then transmitted over the wireless network 400.

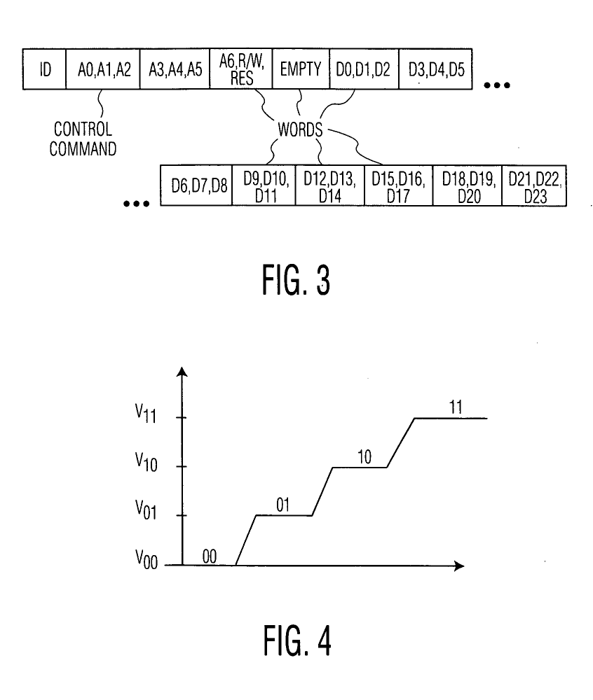

The connector 510 is a multiple line connector, e.g. a bus and the signal BBDATA is a multilevel data signal carried over the multiple-line connector 510. Each line of the connector 510 carries respective components of the data signal BBDATA and each component of the data signal BBDATA may take four values V00, V01, V10 and V11. Each value represents a respective 2 bits value: 00, 01, 10 and 11 as shown in FIG. 4. The signal BBDATA conveys to the baseband system 200 samples of the digital baseband signal associated with the RF signal received by the RF subsystem 100 over the wireless network 400 or, alternately, the signal BBDATA conveys to the RF subsystem 100 samples of a digital baseband signal for transmission over the wireless network 400. Each line of the first connector 150 therefore transmits two bits of each sample of the baseband signal. Such a multilevel signal BBDATA enables to reduce the pin count of the interface 500 and increases its data bandwidth efficiency.

In another embodiment, the performance of the interface 500 may be further improved by increasing the number of voltage levels used for representing binary values of the baseband signal. For example, conveying 3 bits per line is achieved by conveying an eight value-levels signal on each line of the connector 510 with each respective voltage value representing a respective one of the eight possible 3-bits values.

In this embodiment, the baseband signal is time division multiplexed and therefore each sample of the BB signal is transmitted over more than one clock cycle. In this embodiment, each sample of the BB signal comprises an in-phase component I and a quadrature component Q. Each binary component I and Q is 12 bits long and is conveyed in two clock cycles over a respective bus of 3-multilevel-lines with each line conveying 2 bits at a time, as mentioned above. The transmission of the BB signal from the RF subsystem 100 to the BB subsystem 200 is synchronized based on the synchronizing clock BBCLK provided by the BB subsystem 200. Each I and Q component of the BB sample is transmitted over two clock cycles which is equivalent to saying that the BB signal is conveyed at twice the rate of the sampling of the BB signal in the RF subsystem 100. In this embodiment, the BB signal is sampled at a frequency of 40 Hz and the BB samples are transmitted at a frequency of 80 HZ, i.e. the frequency of the synchronizing clock BBCLK.

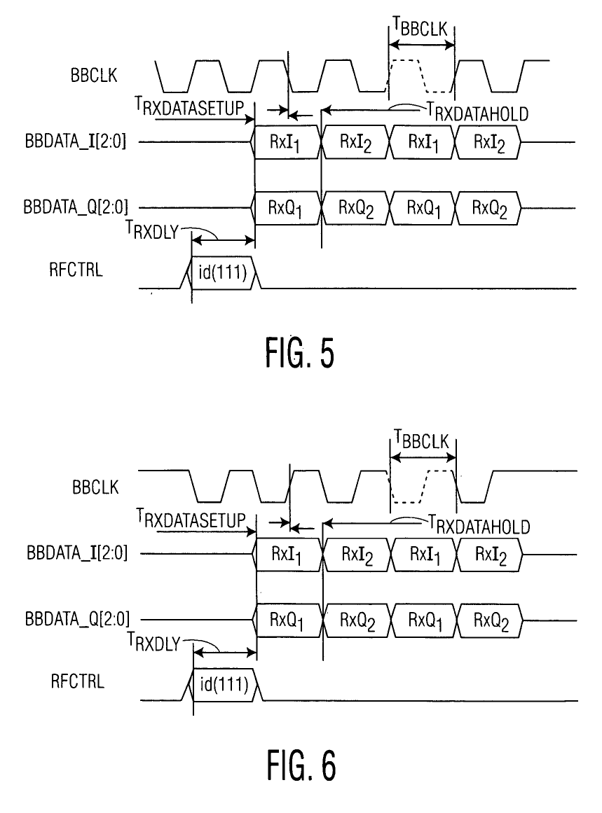

FIG. 5 and FIG. 6 are timing diagrams showing the synchronization process of the BBDATA signal transmitted from the RF subsystem 100 to the BB subsystem 200 with the synchronizing clock BBCLK with a period T_{BBCLK}. FIG. 5 illustrates synchronization on the falling edge of the clock signal BBCLK and FIG. 6 illustrates synchronization on the rising edge of the clock signal BBCLK. FIG. 5 and FIG. 6 show various delays set up for the RF and BB subsystems 100 and 200 to read and write data on the interface 500. A delay T_{RXDLY} is determined to represent the delay between the transmission of the ID word 111 indicating the synchronization of the data signal BBDATA with the clock signal BBCLK and the sampling of the received data signal BBDATA at the baseband subsystem 200. As mentioned above each component I and Q is transmitted over two clock cycles and is therefore divided into RxI1 and RxI2, and RxQ1 and RxQ2, resepectively. Thus, the BB subsystem waits for the duration T_{RXDLY} after transmitting the ID word 111 before reading and detecting the in-phase component RxI1, RxI2 and quadrature component RxQ1, RxQ2 of each sample of the baseband signal conveyed by the data signal BBDATA. Other delays T_{RXDTASETUP} and T_{RXDATAHOLD} are shown in FIG. 5 and FIG. 6. T_{RXDATAHOLD} indicates the time duration during which the voltage on the line of the connector 510 representing bits of the in-phase and quadrature components needs to be stable so that the BB subsystem can detect them without error. T_{RXATASETUP} indicates another a time duration after which the BB subsystem 200 is enabled to sample the received data signal BBDATA. This duration T_{RXDATASETUP} is long enough to permit a well established voltage on the line of the connector 520 and thereby a detection without error of the I and Q components bits. Both durations T_{RXDTASETUP} and T_{RXDATAHOLD} enable a reading of each component RxI1, RxI2 and RxQ1, RxQ2 half way of each component on the rising or falling edge of the clock signal BBCLK when the voltage value is well established on the line.

1. A digital interface in a wireless communication system operable to communicate over a wireless network, the system comprising a baseband subsystem and a radio frequency subsystem interconnected via the interface, the interface comprising the following connectors:
a first connector for providing a synchronizing clock from the baseband subsystem to the radio frequency subsystem to synchronize a data transfer from the radio frequency subsystem to the baseband subsystem;
a second connector for conveying, based on the synchronizing clock signal, a multilevel data signal representative of a baseband communication signal corresponding to a radio frequency communication signal received by the radio frequency subsystem over the wireless network;
a third connector for conveying a control signal from the baseband system to the radio frequency subsystem, the control signal being representative of a command to control an operating mode of the wireless communication system; and
a fourth connector providing a reference clock signal to the base-band subsystem.

2. The interface of claim 1, further comprising:
a fifth connector for conveying from the radio frequency subsystem to the baseband subsystem a signal indicating a strength of the received radio frequency communication signal.

3. The interface of claim 1, wherein the control signal represents commands of variable length based on a timing criticality of the command.

4. The interface of claim 1, wherein the baseband communication signal comprises quadrature and in-phase base-band components.

5. The interface of claim 1, wherein the second connector further conveys the multilevel data signal from the baseband subsystem to the radio frequency subsystem and the multilevel data signal is further representative of a baseband communication signal to be transmitted over the wireless network.

6. The interface of claim 1, wherein the data signal is a four-level data signal and a value of the data signal represents two bits of a sample of the digital baseband signal.

7. The interface of claim 1, wherein the data signal is time division multiplexed.

8. The interface of claim 5, wherein the data signal comprises samples of the baseband communication signal and each sample is conveyed in two clock cycles of the synchronizing clock.

9. The interface of claim 1, wherein the third connector further conveys values of data registers of the radio frequency subsystem in response to the command received by the radio frequency subsystem.

10. The interface of claim 1, wherein the baseband communication signal comprises an in-phase component and a quadrature component and the second connector comprises a first 3-line bus for conveying the quadrature component and a second 3-line bus for conveying the in-phase component.

11. The interface of claim 1, wherein the synchronizing clock signal is operating at twice the frequency of a sampling clock used in the RF subsystem to sample the baseband communication signal.

12. A wireless communication system in a wireless communication system comprising:
a radio frequency subsystem operable to convert a received a radio frequency communication signal over the wireless network to a baseband communication system;
a baseband subsystem;
an interface comprising:
a first connector for providing a synchronizing clock from the base-band subsystem to the RF subsystem to synchronize a data transfer from the RF subsystem to the base-band subsystem;
a second connector for conveying, based on the synchronizing clock signal, a multilevel data signal representative of the baseband communication signal;
a third connector for conveying a control signal from the baseband system to the RF subsystem, the control signal being representative of a command to control an operating mode of the wireless system;
a fourth connector providing a reference clock signal to the base-band subsystem; and,
a fifth connector for conveying to the baseband subsystem a signal indicating a strength of the received radio frequency communication signal.

13. A radio frequency subsystem in a wireless communication system communicating over a wireless network, the radio frequency subsystem comprising:
a first pin for receiving a synchronizing clock from a baseband subsystem of the wireless communication system to synchronize a data transfer from the radio frequency subsystem to the baseband subsystem;
a second pin for transmitting, based on the synchronizing clock signal, a multilevel data signal representative of a baseband communication signal corresponding to a radio frequency communication signal received by the radio frequency subsystem over the wireless network;
a third pin for receiving a control signal from the baseband system, the control signal being representative of a command to control an operating mode of the wireless communication system;
a fourth pin for providing the baseband subsystem with a reference clock signal; and,
a fifth pin for transmitting to the baseband subsystem a signal indicating a strength of the received radio frequency communication signal.

14. A baseband subsystem in a wireless communication system communicating over a wireless network, the baseband system comprising:
a first pin for transmitting a synchronizing clock to a radio frequency subsystem of the wireless communication system to synchronize a data transfer from the radio frequency subsystem to the baseband subsystem;
a second pin for receiving a multilevel data signal representative of a baseband communication signal corresponding to a radio frequency communication signal received by the radio frequency subsystem over the wireless network, the multilevel data signal being transmitted by the radio frequency subsystem based on the synchronizing clock signal;
a third pin for transmitting control signal to the radio frequency subsystem, the control signal being representative of a command to control an operating mode of the wireless communication system;
a fourth pin for receiving a reference clock signal from the radio frequency subsystem; and,
a fifth pin for receiving from the radio frequency subsystem a signal indicating a strength of the received radio frequency communication signal.
